(19) United States
(12) Patent Application Publication
(10) Pub. No.: US 2025/0303376 A1
(43) Pub. Date: Oct. 2, 2025

(54) MIXING DEVICE

(71) Applicant: Kalerm Technology (Suzhou) Co., Ltd, Suzhou (CN)

(72) Inventors: Dean LU, Suzhou (CN); Wang LIU, Suzhou (CN); Wenjia CHEN, Suzhou (CN)

(73) Assignee: Kalerm Technology (Suzhou) Co., Ltd, Suzhou (CN)

(21) Appl. No.: 19/087,948

(22) Filed: Mar. 24, 2025

(30) Foreign Application Priority Data
Mar. 30, 2024 (CN) 202410383221.5

(51) Int. Cl. B01F 35/33; B01F 23/53; B01F 27/90; B01F 35/31; B01F 35/32; B01F 35/50; B01F 35/60; B01F 35/75; B01F 101/14

(52) U.S. Cl. CPC B01F 35/33; B01F 23/53; B01F 27/90; B01F 35/31; B01F 35/3204; B01F 35/3213; B01F 35/54; B01F 35/6052; B01F 35/7547; B01F 2101/14

(57) ABSTRACT

A mixing device includes a supporting base, a mixer assembly, a motor and a transmission mechanism. The supporting base has an installation part, and the mixer assembly is detachably connected to the installation part. The transmission mechanism includes a first transmission member and a second transmission member. The first transmission member is connected to the motor in a transmission manner. The second transmission member is connected to the stirring blade in a transmission manner. The second transmission member and the mixer assembly are connected to or separated from the installation part as an integral unit.

### CROSS-REFERENCE TO RELATED APPLICATIONS

The present application claims priority to Chinese Patent Application 202410383221.5, filed on Mar. 30, 2024, which is hereby incorporated by reference in its entirety.

### TECHNICAL FIELD

The present disclosure relates to the field of technologies of a device for mixing food, ingredients, and the like with a liquid to produce a beverage, and in particular, to a mixing device.

### BACKGROUND

Existing beverage devices, such as a self-service coffee machine, a milk tea machine, generally prepare beverages such as espresso, other coffee beverages, dairy beverages, chocolate beverages by mixing soluble food powders or liquid food concentrates with a liquid. To prepare beverages with different tastes and flavors, a mixer plays a very important role in the existing beverage devices. The mixer is capable of adjusting various setting, for example, a type and blending ratio of powders, a water temperature, a stirring speed, a stirring time to prepare beverages with different tastes and flavors.

A mixer generally includes a mixing chamber, and soluble powders and a liquid are fed in this mixing chamber. A beverage is dispensed and discharged from the bottom of the mixing chamber subsequently for drinking. Since the beverage is prepared by fully mixing the soluble powders and the liquid in the mixer, so that there may be residual beverage or powdery ingredients on a surface and interior of the mixer. Moreover, the mixer is operated in an open environment, and contacts with air and a liquid every day. To prevent the residual beverage or powdery ingredients in the mixer from mildewing and deteriorating, the mixing chamber and its internal parts must be cleaned regularly to avoid bacterial growth and blockage caused by the residues in the mixer.

To perform a cleaning operation, the mixing chamber and its internal parts must be disassembled for cleaning, and then reassembled. Such operation is time-consuming and must be carried out by a professional, such as an operator who specialize in maintaining a beverage preparation machine, thereby avoiding errors and malfunctions in subsequent preparation of a beverage.

However, such cleaning is time-consuming and costly for a user, and it is also difficult for the user to carry out.

### SUMMARY

A purpose of the present disclosure is to provide a mixing device that is convenient for disassembling and cleaning.

To achieve the above-mentioned purpose, the present disclosure provides a mixing device, including:
a supporting base having an installation part;
a mixer assembly detachably connected to the installation part, and including a mixing barrel and a stirring blade located inside the mixing barrel;
a motor disposed on the supporting base, and configured to drive the stirring blade to rotate around a first rotation axis; in which
in a direction perpendicular to the first rotation axis, an axis of the motor is misaligned with the first rotation axis; and the mixing device also includes a transmission mechanism disposed between the motor and the stirring blade, the transmission mechanism is configured to connect the motor and the stirring blade, the transmission mechanism includes a first transmission member and a second transmission member; and the first transmission member is disposed on the installation part, and is connected to the motor in a transmission way, and the second transmission member is connected to the stirring blade in a transmission manner; and
the second transmission member and the mixer assembly are connected to or separated from the installation part as an integral unit.

As a further improvement of an embodiment of the present disclosure, the mixer assembly also includes a coupling part connected to a bottom of the mixing barrel, the coupling part includes a transmission shaft, the transmission shaft connects the second transmission member and the stirring blade, and in an axial direction, the stirring blade is disposed on a side of the coupling part, and the second transmission member is disposed on another side of the coupling part.

As a further improvement of an embodiment of the present disclosure, a discharging outlet is disposed on a side of the coupling part corresponding to the second transmission member, the coupling part defines a supporting space, and a discharging valve is disposed in the supporting space; when the mixer assembly is connected to the installation part, the discharging valve opens the discharging outlet; and when the mixer assembly is separated from the installation part, the discharging valve closes the discharging outlet.

As a further improvement of an embodiment of the present disclosure, the discharging valve includes a valve body and an elastic element acting on the valve body, and the installation part is provided with a butt joint block; and the butt joint block is configured to abut against the valve body, to make the valve body overcome an action of the elastic element to open the discharging outlet.

As a further improvement of an embodiment of the present disclosure, the coupling part is capable of rotating relative to the mixing barrel, to limit or allow the mixer assembly to be separated from the installation part.

As a further improvement of an embodiment of the present disclosure, the mixer assembly is connected to or separated from the installation part in a first direction; a locking part is moveably connected to the coupling part, and the locking part is fixed relative to the coupling part in the first direction; and the locking part moves relative to the coupling part to be locked or unlocked with the installation part in the first direction.

As a further improvement of an embodiment of the present disclosure, the axis of the motor is parallel to the first rotation axis, the mixer assembly is connected to or separated from the installation part in a first direction, the first direction is perpendicular to the first rotation axis; and in the first direction, the axis of the motor is disposed side by side with the first rotation axis, or in a direction perpendicular to the first direction, and the axis of the motor is disposed side by side with the first rotation axis.

As a further improvement of an embodiment of the present disclosure, the mixer assembly also includes a locking part connected to the mixing barrel, and the mixer assembly is connected to or separated from the installation part in a first direction; the locking part is capable of moving relative to the mixing barrel and is fixed relative to the mixing barrel in the first direction; and the locking part is capable of switching between a locking state and an unlocking state relative to the installation part. In the locking state, the installation part limits movement of the locking part in the first direction; and in the unlocked state, the installation part releases the locking part, and the locking part is allowed to move in the first direction.

As a further improvement of an embodiment of the present disclosure, the locking part includes a gripping part, the installation part includes an accommodating cavity for receiving the mixer assembly; in the first direction, the installation part includes an inner side where the accommodating cavity is disposed and an opposite outer side, and the gripping part is located at the outer side; and the gripping part is capable of operably drives the locking part to rotate between the locking state and the unlocking state.

As a further improvement of an embodiment of the present disclosure, the first rotation axis is disposed in a vertical direction, and the first direction is perpendicular to the first rotation axis; and a rotation axis of the locking part is coaxial with the first rotation axis, or the rotation axis of the locking part is parallel to the first direction.

As a further improvement of an embodiment of the present disclosure, a liquid inlet pipeline is connected to the supporting base, and the liquid inlet pipeline communicates with the mixing barrel in the first direction.

As a further improvement of an embodiment of the present disclosure, the mixing barrel includes a feeding chamber and a mixing chamber communicating with each other in a vertical direction, the stirring blade is located in the mixing chamber, the locking part includes a connecting body that is concentrically arranged with the stirring blade, the gripping part extends outwards from an outer circumference of the connecting body, and the connecting body is disposed below the mixing chamber.

As a further improvement of an embodiment of the present disclosure, the installation part includes a top plate, a bottom plate, and a side plate, the top plate and the bottom plate are disposed opposite to each other in a vertical direction, and the side plate connects the top plate and the bottom plate; the top plate, the bottom plate, and the side plate define an accommodating cavity together, the accommodating cavity has an installation opening, the top plate is provided a placing groove communicating with the installation opening, and the mixer assembly enters the placing groove in the first direction from the installation opening; and a portion of the mixer assembly is located in the accommodating cavity, and is limited by the top plate in the first rotational axis direction.

As a further improvement of an embodiment of the present disclosure, the mixing barrel includes a feeding chamber and a mixing chamber communicating with each other in a vertical direction, the stirring blade is located inside the mixing chamber, the bottom of the mixing chamber radially extends outwards to form a skirt edge, and the skirt edge is limited by the top plate.

As a further improvement of an embodiment of the present disclosure, the mixing barrel includes a feeding chamber and a mixing chamber communicating with each other in a vertical direction, the stirring blade is located inside the mixing chamber, the mixing barrel includes a contraction portion, the contraction portion is disposed at a joint between the feeding chamber and the mixing chamber, the contraction portion enters the placing groove, and a top wall of the mixing chamber is limited by the top plate.

As a further improvement of an embodiment of the present disclosure, the connecting body includes two arc-shaped walls disposed opposite to each other and two straight walls, and the two straight walls are separately connected to the two arc-shaped walls; the two arc-shaped walls are concentrically arranged with the stirring blade, and a distance between the two straight walls is substantially the same as a width of the installation opening; the installation part is provided with a blocking wall, and in the locking state, one of the two straight walls abuts against the blocking wall; and in the unlocking state, the two straight walls are respectively flush with the installation opening.

As a further improvement of an embodiment of the present disclosure, the locking part also includes a locking block protruding from the gripping part, the installation part is provided with a locking groove. The gripping part is capable of moving relative to the mixing barrel to make the locking block engage into or disengage from the locking groove.

### BRIEF DESCRIPTION OF THE DRAWINGS

FIG. 1 is a three-dimensional schematic diagram of a mixing device according to an embodiment of the disclosure, in which the mixing device is in a locking state.

FIG. 2 is a sectional view of the mixing device in FIG. 1 along a line A-A.

FIG. 3 is a front view of the mixing device in FIG. 1.

FIG. 4 is a sectional view of the mixing device in FIG. 3 along a line B-B.

FIG. 5 is a sectional view of the mixing device in FIG. 3 along a line C-C.

FIG. 6 is an exploded three-dimensional schematic diagram of a mixer assembly of the mixing device in FIG. 1.

FIG. 7 is a three-dimensional schematic diagram of a coupling part of the mixing device in FIG. 1 from another perspective.

FIG. 8 is a three-dimensional schematic diagram of the mixing device in FIG. 1, in which the mixing device is in an unlocking state.

FIG. 9 is a sectional view of the mixing device in FIG. 8 along a line D-D.

FIG. 10 is a three-dimensional schematic diagram of the mixing device in FIG. 8, in which a mixer assembly is separated from a supporting base of the mixing device.

FIG. 11 is a three-dimensional schematic diagram of a mixing device according to another embodiment of the disclosure.

FIG. 12 is a front view of the mixing device in FIG. 11.

FIG. 13 is a sectional view of the mixing device in FIG. 12 along a line E-E.

FIG. 14 is a sectional view of the mixing device in FIG. 12 along a line F-F.

FIG. 15 is a three-dimensional schematic diagram of the mixing device in FIG. 11, in which one of mixer assemblies of the mixing device is removed from the supporting base.

FIG. 16 is a three-dimensional schematic diagram of a mixer assembly of the mixing device in FIG. 11.

FIG. 17 is an exploded three-dimensional schematic diagram of the mixer assembly in FIG. 16.

FIG. 18 is a three-dimensional schematic diagram of the mixer assembly in FIG. 16 from another perspective.

FIG. 19 is a three-dimensional schematic diagram of a mixing device according to yet another embodiment of the disclosure.

FIG. 20 is a sectional view of the mixing device in FIG. 19 along a line G-G.

FIG. 21 is a three-dimensional schematic diagram of the mixing device in FIG. 19, in which a mixer assembly is separated from the supporting base of the mixing device.

FIG. 22 is an exploded three-dimensional schematic diagram of the mixer assembly of the mixing device in FIG. 19.

### DETAILED DESCRIPTION OF THE EMBODIMENTS

The present disclosure will be described in detail with reference to the specific embodiments shown in the accompanying drawings. However, these embodiments do not intend to limit the present disclosure. Structural, methodological, or functional variations made by a person skilled in the art according to these embodiments are included in the protection scope of the present disclosure.

It should be understood that, terms used in the specification indicate spatial relative positions, such as “upper”, “above”, “lower”, “below”, are used for describing a relationship between one unit or feature relative to another unit or feature as shown in the accompanying drawings for the purpose of facilitating illustration. The terms relating to the spatial relative positions are aimed at including different orientations of a device during use or an operation, in addition to those orientations shown in the accompanying drawings.

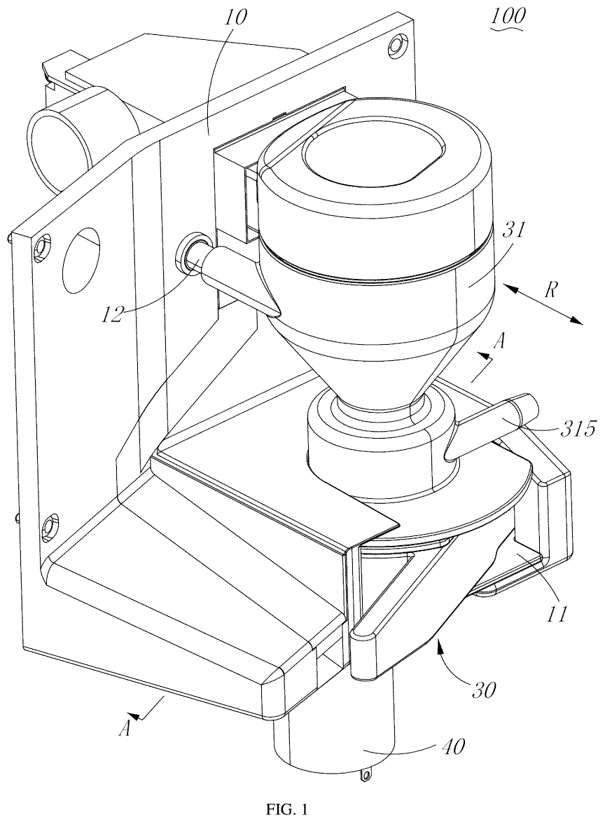

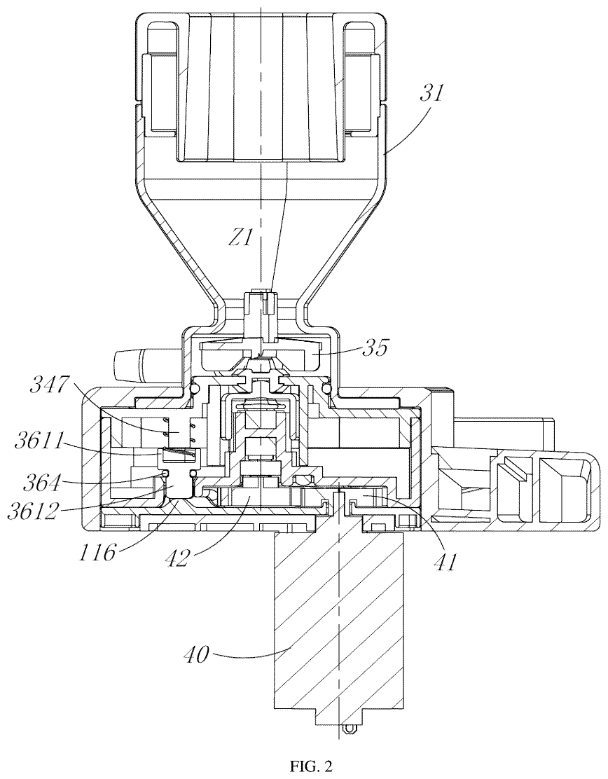

A mixing device in specific embodiments of the present disclosure will be described by taking a mixing device 100 for preparing a beverage by mixing powders and water as an example. Referring to FIG. 1 and FIG. 2, in an implementation, the mixing device 100 includes a supporting base 10, a mixer assembly 30 installed on the supporting base 10, and a motor 40 disposed on the supporting base 10. The supporting base 10 may be a housing or a structure for supporting or connecting a functional part. The supporting base 10 has an installation part 11, and the mixer assembly 30 is connected to the installation part 11. The mixer assembly 30 includes a mixing barrel 31 and a stirring blade 35 located inside the mixing barrel 31. The mixing barrel 31 is used for accommodating powders and water, and the powder to be mixed may fall into interior of the mixing barrel 31 from an upper opening of the mixing barrel 31. A liquid inlet pipeline 12 is connected to the supporting base 10, and the water to be mixed may be delivered to the interior of the mixing barrel 31 through the liquid inlet pipeline 12 communicating with the mixing barrel 31. The motor 40 drives the stirring blade 35 to rotate around a first rotation axis Z1, thereby stirring a mixture inside the mixing barrel 31. In a horizontal direction, an axis of the motor 40 is misaligned with the first rotation axis Z1. Such misalignment arrangement may be parallel or intersecting, that is, the axis of motor 40 is not collinear with the first rotation axis Z1.

The mixing device 100 also includes a transmission mechanism disposed between the motor 40 and the stirring blade 35. The transmission mechanism includes a first transmission member 41 and a second transmission member 42. The first transmission member 41 is disposed on the installation part 11, and is connected to the motor 40 in a transmission manner. The second transmission member 42 is connected to the stirring blade 35 in a transmission manner. The mixer assembly 30 is detachably connected to the installation part 11. The second transmission member 42 and the mixer assembly 30 are connected to or separated from the installation part 11 as an integral unit, so that it very convenient for a user to disassemble and assemble.

It should be noted that, the first transmission member 41 and the second transmission member 42 may be in directly or indirectly transmission connection, for example, they may be in transmission connection through other transmission members. In an example, the first transmission member 41 and the second transmission member 42 may be connected through a third transmission member (for example, a gear).

By the second transmission member 42 and the mixer assembly 30 being connected to or separated from the installation part 11 as an integral unit, a user may disassemble the mixer assembly 30 by themselves for subsequent cleaning. Disassembly and assembly may be achieved simply by separating or connecting the integral unit in a corresponding direction, without the need for a professional to perform disassembly and maintenance, so that a maintenance cost of the mixing device 100 for the user is reduced.

Compared with conventional technologies, beneficial effects of the present disclosure lie in the following: By the second transmission member 42 and the mixer assembly 30 being connected to or separated from the installation part 11 as an integral unit, a user may disassemble the mixer assembly 30 by themselves for subsequent cleaning. Disassembly and assembly may be achieved simply by separating or connecting the integral unit in a corresponding direction, without the need for a professional to perform disassembly and maintenance, so that a maintenance cost of the mixing device 100 for the user is reduced. By disassembling the entire mixer assembly 30 from the supporting base 10, a more thorough cleaning may be achieved. At the same time, there is no requirement for disassembling the motor 40 together, nor is it necessary to provide a corresponding clearance structure for the motor 40, so that a space utilization of the machine is increased, and the disassembly operation by the user is facilitated.

In an embodiment, the axis of motor 40 is parallel to the first rotation axis Z1 of the stirring blade 35, that is, the axis of motor 40 is offset to the first rotation axis Z1 of the stirring blade 35. The mixer assembly 30 is connected to or separated from the installation part 11 in a first direction (as indicated by an arrow R in FIG. 1), and the axis of the motor 40 and the first rotation axis Z1 of the stirring blade 35 are arranged side by side in a direction perpendicular to the first direction. In the present disclosure, a direction for disassembling and installing the mixer assembly 30 is defined as the first direction, and the first direction is parallel to the horizontal direction. A direction for disassembling the mixer assembly 30 is defined as a front side of the first direction, a direction for installing the mixer assembly 30 is defined as a rear side of the first direction, and two sides of the first direction are respectively defined as a left side and a right side. A direction along the first rotation axis Z1 of the stirring blade 35 is a vertical direction. The axis of the motor 40 and the first rotation axis Z1 of the stirring blade 35 are arranged side by side in a left-right manner. It may also be considered that the first transmission member 41 and the second transmission member 42 are disposed side by side. In an example, the first transmission member 41 and the second transmission member 42 are both constructed as gears. With the rotating engagement and disengagement of the two gears, the disassembly and the installation of the mixer assembly 30 are facilitated.

It may be understood that, the first transmission member 41 and the second transmission member 42 may also be connected in other transmission manners, and are not limited to gear transmission. For example, they may be connected through sprocket transmission.

In addition, the liquid inlet pipeline 12 may also be configured to communicate with the mixing barrel 31 in the first direction. When the mixer assembly 30 is connected to or separated from the installation part 11, the connection and the disconnection of a water passage is simultaneously achieved.

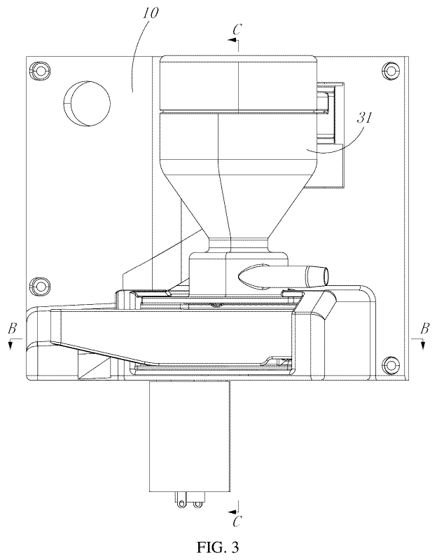

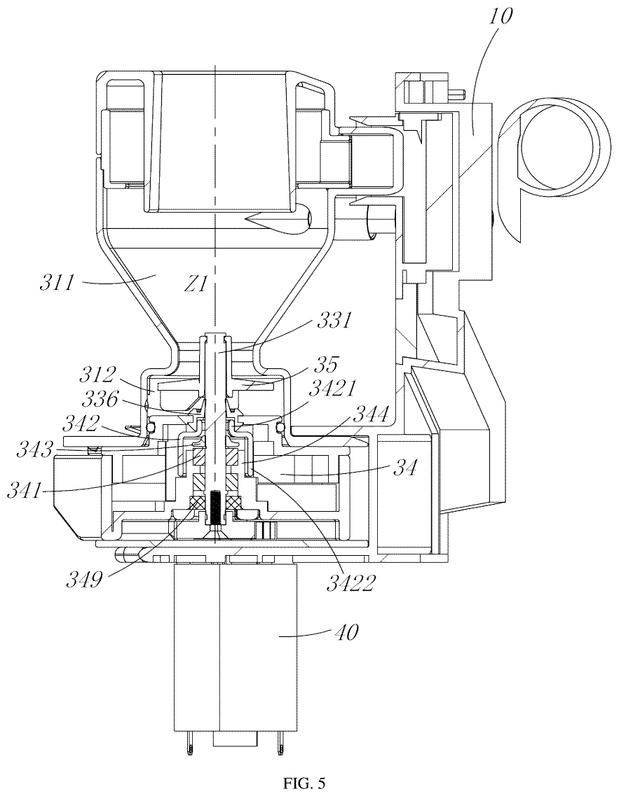

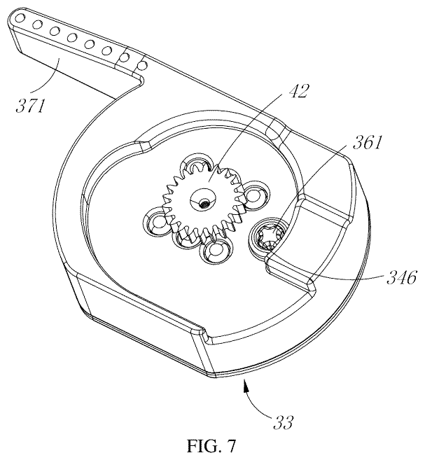

Referring to FIG. 2 to FIG. 7, the mixer assembly 30 also includes a coupling part 33 detachably connected to a bottom of the mixing barrel 31. The coupling part 33 includes a transmission shaft 331 which respectively connects the second transmission member 42 and the stirring blade 35. The stirring blade 35 is disposed on a side of the coupling part 33 in an axial direction. The second transmission member 42 is disposed on another side of the coupling part 33 in the axial direction. In the present disclosure, the axial direction of the coupling part 33 is an axial direction of the transmission shaft 331. The coupling part 33 is provided such that a support for the transmission shaft 331 may be provided, and thus transmission between the motor 40 and the stirring blade 35 is more reliable. Moreover, the coupling part 33 may provide a reliable installation space for a supporting part 341 of the transmission shaft 331, and may also facilitate sealing.

The coupling part 33 may include an upper cover 332 and a lower cover 333 which are assembled together by screws. A supporting space 34 is defined between the upper cover 332 and the lower cover 333, and the supporting part 341 such as a bearing, a shaft sleeve, and the like may be installed in the supporting space 34. A sealing ring 336 is disposed between the transmission shaft 331 and the upper cover 332, to prevent a liquid inside the mixing barrel 31 from leaking through a gap between the transmission shaft 331 and the upper cover 332. The upper cover 332 is also provided with an installation boss 335, and the installation boss 335 extends into the interior of the mixing barrel 31. A sealing loop 337 is disposed between the installation boss 335 and the interior of the mixing barrel 31, to prevent the liquid inside the mixing barrel 31 from leaking through a gap between the mixing barrel 31 and the upper cover 332. By providing the sealing ring 336 and the sealing loop 337, it is ensured that the liquid inside the mixing barrel 31 will not leak downwards to the coupling part 33, the transmission mechanism, and the motor 40.

In addition, in order to further enhance the sealing effect, a portion of the sealing ring 336 located in the supporting space 34 is also connected to a first guide ring 342. A bearing is supported on a bearing supporting part 344 located on the lower cover 333. An end in an axial direction of the first guide ring 342 forms a retraction part 3421. The retraction part 3421 extends into an inner side of the sealing ring 336. The first guide ring 342 also includes a widen mouth part 3422 connected below the retraction part 3421, and the widen mouth part 3422 is sleeved on an outer periphery of the bearing supporting part 344. If there is a liquid flowing out between the sealing ring 336 and the upper cover 332, the liquid may be drawn out to an outer side of the bearing supporting base 344 through the first guide ring 342. Furthermore, at a position misaligned from the retraction part 3421, the transmission shaft 331 is also provided a second guide ring 343, and the second guide ring 343 is disposed inside the first guide ring 342. A size or diameter in a radial direction of the second guide ring 343 is greater than a size or diameter of a bearing. If there is a liquid flowing out between the sealing ring 336 and the transmission shaft 331, the liquid may be drawn out to the bearing supporting part 344 through the second guide ring 343. The lower cover 333 is provided with a discharging outlet 346, that is, the discharging outlet 346 is disposed on a side of the coupling part 33 corresponding to the second transmission member 42, and the discharging outlet 346 is also disposed at a position on the coupling part 33 away from the first transmission member 41. Since the coupling part 33 has a sealing structure inside, even if water leakage occurs, an amount of the leaked liquid is relatively small, the leaked liquid may be drawn out by the first guide ring 342 and the second guide ring 343, and then be discharged from the discharging outlet 346 of the lower cover 333. When the water flows out from the discharging outlet 346, it will not directly contact or diffuse to the first transmission member 41. The first guide ring 342 and the second guide ring 343 may be made of a same or similar material as the sealing ring 336, which may not only guide the liquid, but also further enhance a sealing effect.

Furthermore, there is a sealing member 349 disposed between the bearing supporting part 344 and the transmission shaft 331. The sealing member 349 may be disposed between the second transmission member 42 and the supporting part 341, and the sealing member 349 may be constructed as an oil seal to prevent water ingress during cleaning.

In the present disclosure, the coupling part 33 may be disassembled together with the mixing barrel 31, and may also be disassembled from the mixing barrel 31. In order to prevent water from entering the coupling part 33 caused by a user's misoperation during cleaning, a discharging valve 36 is disposed in the supporting space 34 of the coupling part 33. As the mixer assembly 30 is connected to or separated from the installation part 11, the discharging valve 36 is capable of opening or closing the discharging outlet 346. The discharging valve 36 is capable of automatically opening and closing the discharging outlet 346 with the installation and the disassembly of the mixer assembly 30, without causing operational inconvenience for a user during cleaning of the mixer assembly 30. At the same time, it may prevent water from entering the coupling part 33, so that a service life of the mixer assembly 30 is improved.

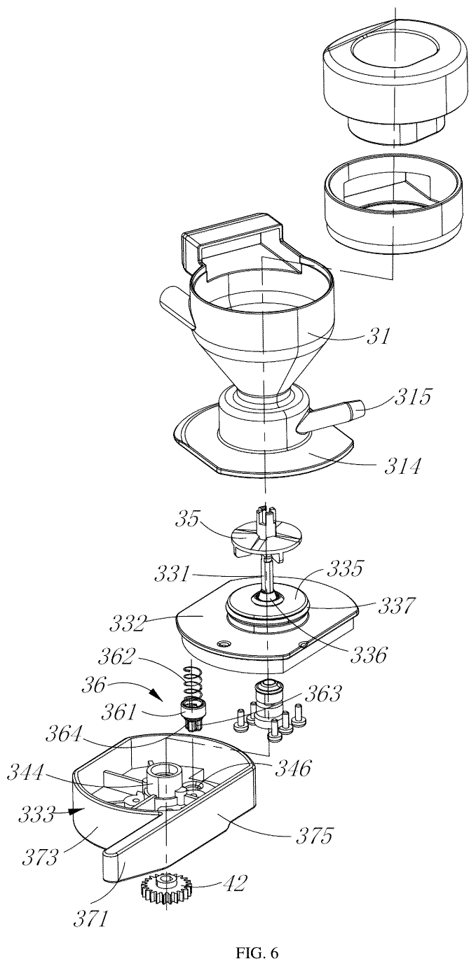

Referring to FIG. 2 and FIG. 6, the discharging valve 36 includes a valve body 361 and an elastic element 362 acting on the valve body 361. A butt joint block 116 is disposed on the installation part 11, the butt joint block 116 abuts against the valve body 361 to make the valve body 361 overcome the action of the elastic element 362, to allow the valve body 361 to open the discharging port 346. The butt joint block 116 is disposed on the installation part 11, when the mixer assembly 30 is installed, the discharging outlet 346 is opened simultaneously without an additional operation performed by a user. Among them, the elastic element 362 is constructed as a compression spring, an end of the compression spring is sleeved on a supporting rib 347 located on the upper cover 332, and another end of the compression spring is pressed against the valve body 361. The valve body 361 is constructed in a cylindrical shape, and includes a cap part 3611 and a plug part 3612 in an axial direction thereof. A part of the compression spring extends into interior of the cap part 3611, and the plug part 3612 has a groove 363 disposed in the axial direction. The groove 363 may be one groove, or may be a plurality of grooves spaced circumstantially. A sealing element 364 is sleeved on the valve body 361, and the sealing element 364 is located between the cap part 3611 and the plug part 3612. A diameter of the cap part 3611 is greater than that of the discharging outlet 346. When the mixer assembly 30 is disassembled from the installation part 11, the valve body 361 moves downwards, the sealing element 364 seals the discharging outlet 346, and the cap part 3611 may also prevent the discharging valve 36 from being directly ejected. When the mixer assembly 30 is connected to the installation part 11, the valve body 361 moves upwards, the discharging outlet 346 may communicate with both interior and exterior of the coupling part 33 through the groove 363.

In an example, the coupling part 33 rotates relative to the mixing barrel 31 to limit or allow the disassembly of the mixer assembly 30 from the installation part 11. By rotating the coupling part 33, the mixer assembly 30 is locked with or unlocked from the installation part 11, so that a reliable use of the mixing device 100 is ensured. Moreover, it is not necessary to provide an additional locking structure, the locking is achieved by the mixer assembly 30 itself, so that the structure is simpler. Among them, the coupling part 33 serves as a locking part, and the rotation of the locking part relative to the mixing barrel 31 is capable of achieving that the locking part abuts against or is separated from the installation part 11 in the first direction. Certainly, the locking part may be one of the upper cover 332 or the lower cover 333, or other parts on the coupling part 33 which is locked and unlocked by abutting against or being separated from the installation part 11 in the first direction. Therefore, the structure is simple, and is easy to manufacture.

Certainly, the locking part may also be a part independent of the coupling part 33. The locking part is connected to the mixing barrel 31, either directly or indirectly through other parts. The locking part is capable of moving relative to the mixing barrel 31, and is fixed relative to the mixing barrel 31 in the first direction. The locking part is capable of switching between a locking state and an unlocking state relative to the installation part 11. In the locking state, the installation part 11 limits movement of the locking part in the first direction. In the unlocking state, the installation part 11 releases the locking part, and the locking part is allowed to move in the first direction. By providing the locking part connected to the mixing barrel 31, it is not only convenient for a cooperation with the installation part 11, but also facilitating the locking and unlocking of the mixer assembly 30 relative to the installation part 11, and meanwhile, the reliable use of the mixer assembly 30 is ensured.

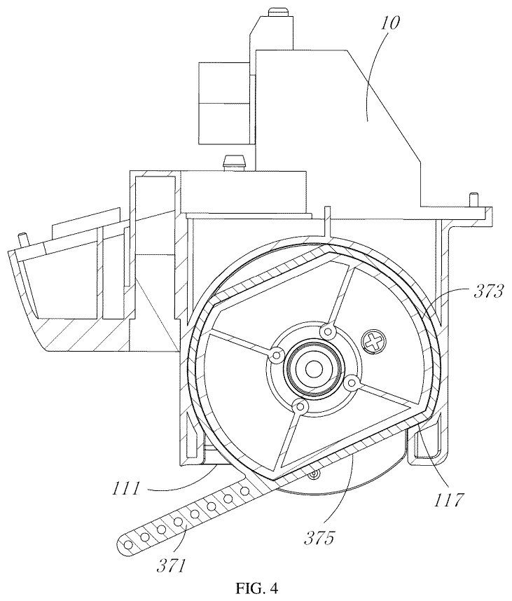

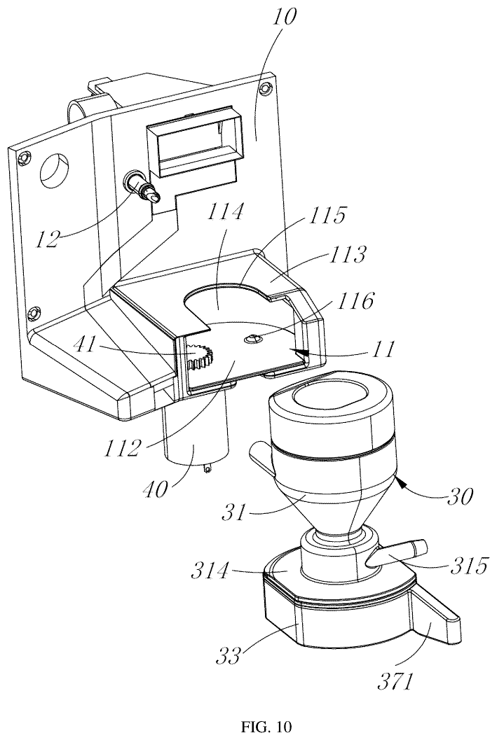

Referring to FIG. 4 and FIG. 6 to FIG. 11, the locking part includes a gripping part 371, and the installation part 11 includes an accommodating cavity 110 for receiving the mixer component 30. In the first direction, the installation part 11 includes an inner side where the accommodating cavity 110 is disposed and an opposite outer side. The gripping part 371 is located at the outer side, and the gripping part 371 operably drives the locking part to rotate between the locking state and the unlocking state. The locking part is provided with the gripping part 371, so that the unlocking, the disassembly, the installation and the locking of mixer assembly 30 is achieved in one-touch operation, and thus it is very convenient for the user. In the present embodiment, the inner side is a rear side, and the outer side is a front side.

In an example, the first rotation axis Z1 is disposed in a vertical direction and perpendicular to the first direction, that is, the first direction is parallel to the horizontal direction. The rotation axis of the locking part is coaxial with the first rotation axis Z1, facilitating the assembly and the positioning of the locking part and the mixing barrel 31. A rotating plane of the stirring blade 35 is substantially perpendicular to a powder falling direction, so that a risk of clogging when the water powder ratio is low (when a concentration is higher) is reduced. The mixing barrel 31 includes a feeding chamber 311 and a mixing chamber 312 communicating with each other in the vertical direction, and the stirring blade 35 is located inside the mixing chamber 312. The locking part includes a connecting body concentrically arranged with the stirring blade 35, that is, the main body portion of the lower cover 333 is constructed as the connecting body, the gripping part 371 extends outwards from an outer periphery of the connecting body, and the connecting body is disposed below the mixing chamber 312. A rotation axis of the connecting body is concentrically arranged with the stirring blade 35, which facilitates positioning and connection of the connecting body.

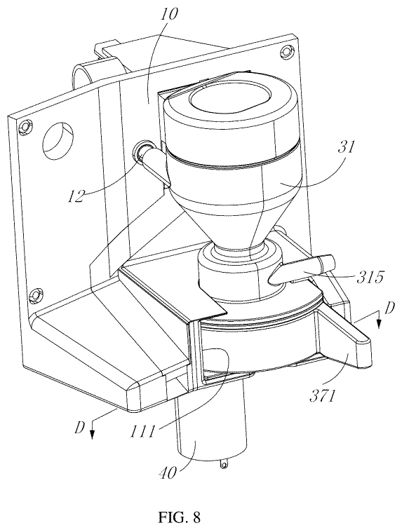

Referring to FIG. 8 to FIG. 10, the installation part 11 includes a top plate 113, a bottom plate 112, and a side plate 114. The top plate 113 and the bottom plate 112 are disposed opposite to each other in the vertical direction, and the side plate 114 connects the top plate 113 and the bottom plate 112. The top plate 113, the bottom plate 112, and the side plate 114 define an accommodating cavity 110 together. The side plate 114 includes a left side plate and a right side plate. The accommodating cavity 110 has an installation opening 111, a placing groove 115 is disposed on the top plate 113 and communicates with the installation opening 111. The mixer assembly 30 enters the placing groove 115 from the installation opening 111 in the first direction. A portion of the mixer assembly 30 is located in the accommodating cavity 110, and is limited by the top plate 113 in the direction of the first rotation axis Z1. The direction of the first rotation axis Z1 is the vertical direction, and the installation part 11 ensures the reliable use of the mixer assembly 30 by limiting its movement in the vertical direction. In an example, the bottom of the mixing chamber 312 radially extends outwards to form a skirt edge 314, and the skirt edge 314 is limited by the top plate 113. The skirt edge 314 facilitates limitation of the mixing barrel 31 in the vertical direction. When the mixing barrel 31 is connected to the coupling part 33, the skirt edge 314 may increase a contact area with the coupling part 33, so that a stable support for the mixing barrel 31 is ensured. Moreover, the mixing chamber 312 is located above the installation part 11, which facilitates discharge of the mixed liquid.

Furthermore, the connecting body includes two arc-shaped walls 373 disposed opposite to each other and two straight walls 375, and the two straight walls 375 are disposed opposite to each other and separately connected to the two arc-shaped walls 373. The two arc-shaped walls 373 are concentrically arranged with the stirring blade 35, and a distance between the two straight walls 375 is equivalent to a width of the installation opening 111 (that is, a distance between the two straight walls 375 is substantially the same as a width of the installation opening 111). The installation part 11 is provided with a blocking wall 117, and in the locking state, one of the two straight walls 375 abuts against the blocking wall 117. In the unlocking state, the two straight walls 375 are respectively flush with the installation opening 111. The connecting body is locked and unlocked with the installation part 11 by rotating the connecting body and utilizing its truncated circular profile. This design is simple in the structure and convenient for being operated. The side plate 114 of the accommodating cavity 110 may be shaped to fit with the arc-shaped wall 373 to ensure a more reliable structure. Among them, the gripping part 371 may extend outwards in a direction which is flush with the straight wall 375 abutting against the blocking wall 117. In the unlocking position, the gripping part 371 substantially extends outwards in the first direction, so that there is a greater gripping area, and thus it is convenient for operation. In the locking position, the gripping part 371 is closer to the supporting base 10, so that an occupying space is small. The blocking wall 117 may be a portion of the side plate 114, and is used for cooperating with one of the straight walls 375 in the locking position, to prevent excessive rotation of the connecting body. The straight wall 375 that cooperates with the blocking wall 117 is connected to the gripping part 371, this the straight wall 375 is relatively long, and abuts against the installation opening 111 when the connecting body is rotated to the unlocking position, so that the excessive rotation of the connecting body is prevented.

In the present embodiment, the locking part is the coupling part 33. In other feasible manners, the locking part may also be one of the upper cover 332 and the lower cover 333, or it may be a part different from the upper cover 332 or the lower cover 333, such as a connecting ring movably sleeved on the coupling part 33, or a connecting ring movably sleeved on the mixing barrel 31.

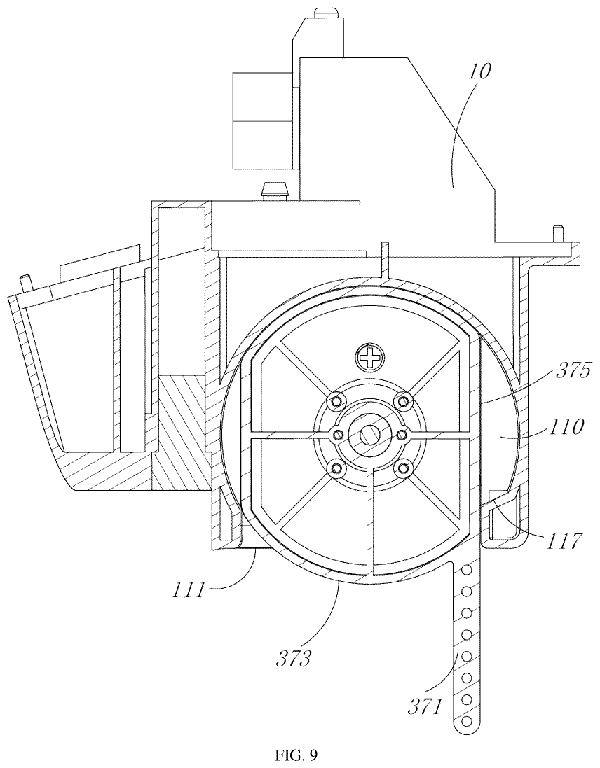

In the following, disassembly and installation processes of the mixer assembly 30 will be described in details. FIG. 1 and FIG. 4 show the mixer assembly 30 in the locking state. When it is necessary to clean the mixer assembly 30, a force is applied to the gripping part 371 in an unlocking direction. The gripping part 371 drives the locking part (the coupling part 33) to rotate relative to the installation part 11. One section of the straight wall 375 is separated from the blocking wall 117, until this section of the straight wall 375 abuts against a side wall of the installation opening 111, and then the locking between the locking part and the installation part 11 in the first direction is released. FIG. 8 and FIG. 9 show the mixer assembly 30 in the unlocking state. Since the locking part is rotated relative to the mixing barrel 31, during an unlocking process, a position of the mixing barrel 31 is unchanged relative to the supporting base 10. After being unlocked, the gripping part 371 moves outwards, and the gripping part 371 will drive the locking part (the coupling part 33), the mixing barrel 31, and the second transmission member 42 to be separated from the supporting base 10 together. The unlocking, disassembly, installation, and locking of the mixer assembly 30 on the installation part 11 may all be achieved by operating the gripping part 371. By the one-touch operation on the gripping part 371, operation steps for a user are greatly simplified, so that experience of the user is improved, and thus convenience is provided to the user. If it is required to continue to separate the locking part form the mixing barrel 31, it may be implemented by simply moving the locking part (the coupling part 33) relative to the mixing barrel 31 in the first rotation axis Z1 direction of the stirring blade 35. If it is required to clean the stirring blade 35 separately, the stirring blade 35 is removed from the transmission shaft 331, and then them are installed to their original position one by one after cleaning. By disassembling the entire mixer assembly 30 from the supporting base 10, a more thorough cleaning may be performed. Meanwhile, it is not necessary to remove the motor 40 together or provide a corresponding relief structure for the motor 40, so that a space utilization of the machine is increased, and it is convenient for a user to disassemble.

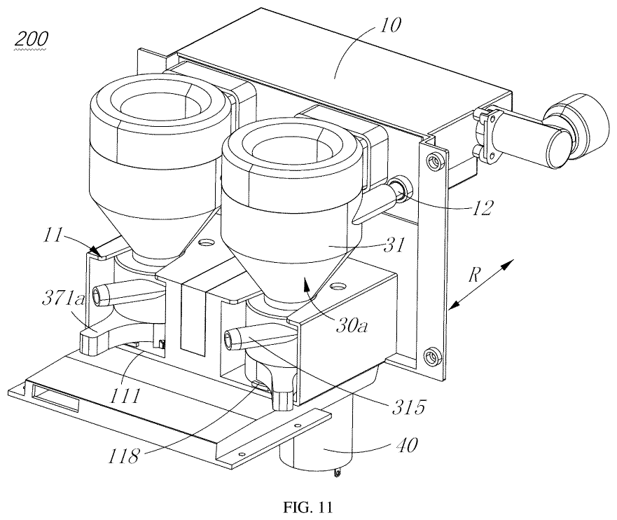

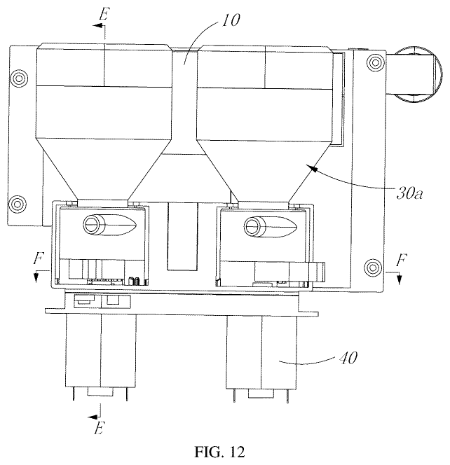

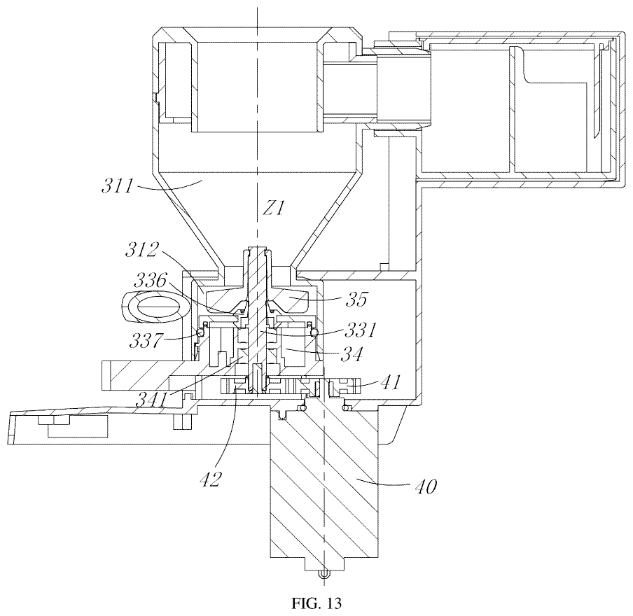

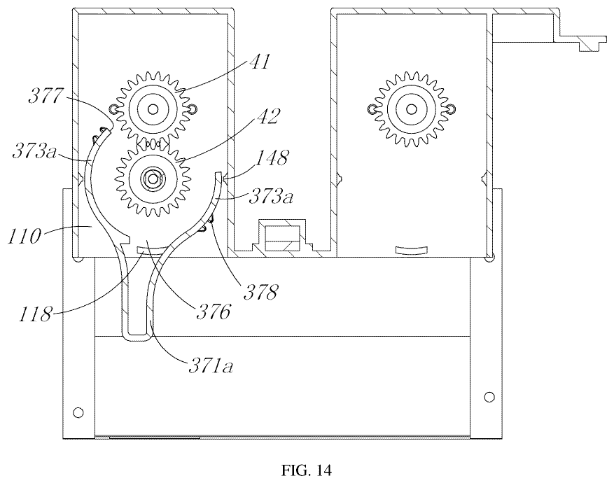

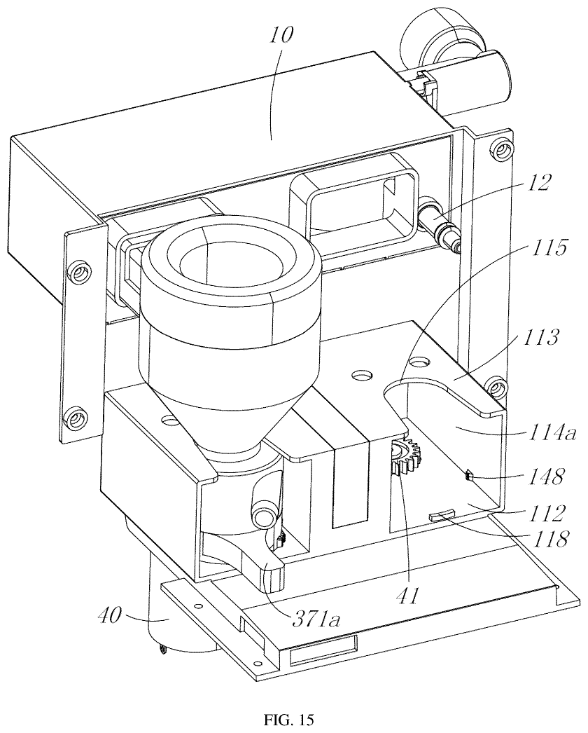

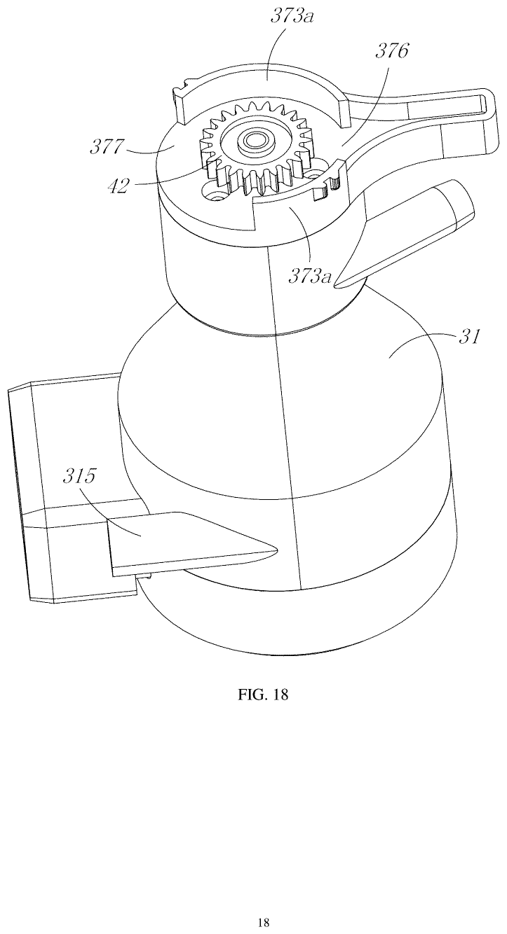

Referring to FIG. 11 to FIG. 18, in another embodiment, the mixing device 200 includes a supporting base 10, a mixer assembly 30a installed on the supporting base 10, and a motor 40 disposed on the supporting base 10. The supporting base 10 has an installation part 11, and the mixer assembly 30a is connected to the installation part 11. The mixer assembly 30a includes a mixing barrel 31 and a stirring blade 35 located inside the mixing barrel 31. The motor 40 is used for driving the stirring blade 35 to rotate around a first rotation axis Z1, to stir a mixture in the mixing barrel 31. A quantity of the mixer assembly 30a may be one, two or even more. Based on difference powders to be mixed, two or even more mixer assembly 30a are provided.

The mixing device 200 also includes a transmission mechanism disposed between the motor 40 and the stirring blade 35. The transmission mechanism includes a first transmission member 41 and a second transmission member 42. The first transmission member 41 is disposed on the installation part 11, and is connected to the motor 40 in a transmission manner, and the second transmission member 42 is connected to the stirring blade 35 in a transmission manner.

The mixer assembly 30a is detachably connected to the installation part 11. The second transmission member 42 and the mixer assembly 30a are connected to or separated from the installation part 11 as an integral unit, so that it is very convenient for a user to disassemble and assemble.

In an example, the mixer assembly 30a is detachably connected to the installation part 11 in a first direction, and a liquid inlet pipeline 12 is connected to the supporting base 10. The liquid inlet pipeline 12 communicates with the mixing barrel 31 in the first direction, so that connection or disconnection of a water passage is achieved when the mixer assembly 30a is installed or disassembled.

An axis of motor 40 is parallel to the first rotation axis Z1 of the stirring blade 35, and the axis of the motor 40 is arranged side by side with the rotation axis Z1 of the stirring blade 35 in the first direction. That is, the rotation axis Z1 of the stirring blade 35 is arranged side by side with the axis of the motor 40 in a front to rear direction, and the first transmission member 41 and the second transmission member 42 are arranged side by side. The first transmission member 41 and the second transmission member 42 are constructed as gears arranged side by side in the front to rear direction, so that engagement and disengagement operations are more effortless, and thus it is convenient for the disassembly and the installation of the mixer component 30.

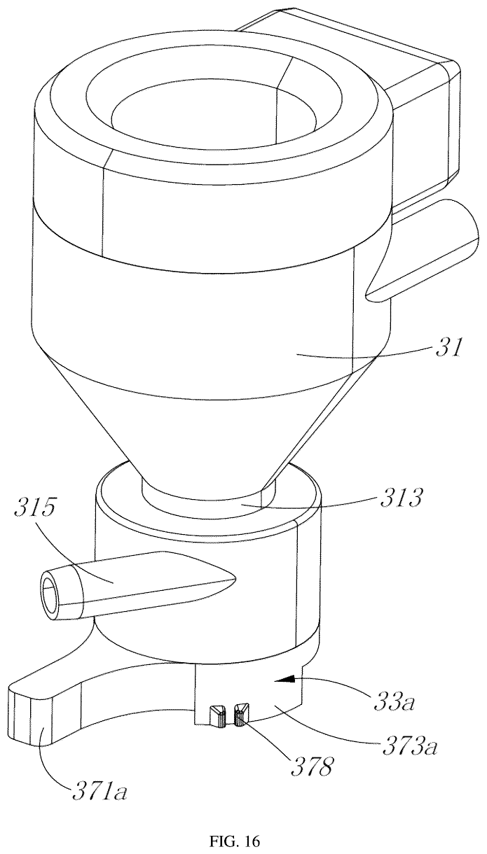

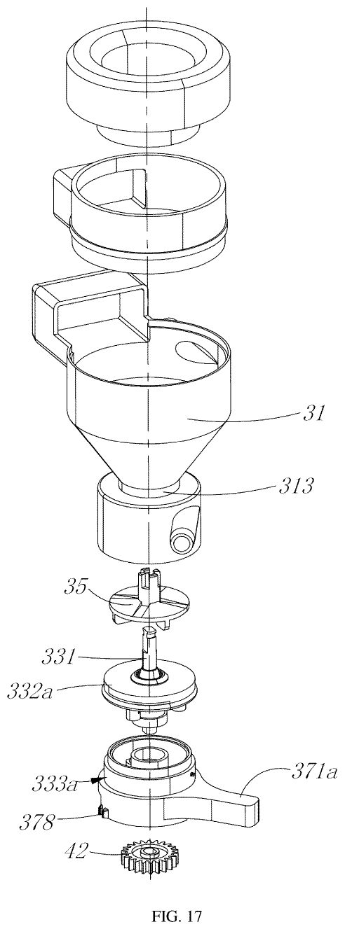

Referring to FIG. 16 and FIG. 17, the mixer assembly 30a also includes a coupling part 33a detachably connected to a bottom of the mixing barrel 31. The coupling part 33a includes a transmission shaft 331 which connects the second transmission member 42 and the stirring blade 35. The stirring blade 35 is disposed on a side of the coupling part 33a in an axial direction, and the second transmission member 42 is disposed on another side of the coupling part 33a in the axial direction. The coupling part 33a may include an upper cover 332a and a lower cover 333a which are assembled together by screws. A supporting space 34 is defined between the upper cover 332a and the lower cover 333a, and a supporting part 341, such as a bearing, a shaft sleeve, and the like may be mounted in the supporting space 34. A sealing ring 336 is disposed between the transmission shaft 331 and the upper cover 332a, to prevent a liquid inside the mixing barrel 31 from leaking through a gap between the transmission shaft 331 and the upper cover 332a. A portion of the lower cover 333a protrudes upwards, and extends into interior of the mixing barrel 31 with the upper cover 332a. A sealing loop 337 is disposed between the lower cover 333a and the interior of the mixing barrel 31, to prevent the liquid inside the mixing barrel 31 from leaking through a gap between the mixing barrel 31 and the lower cover 333a.

In an example, the coupling part 33a is rotated relative to the mixing barrel 31, to limit or allow the mixer assembly 30a to be separated from the installation part 11. By rotating the coupling part 33a, the mixer assembly 30a is locked with or unlocked from the installation part 11, to ensure a reliable use of the mixing device 200. Moreover, it is not necessary to provide an additional locking structure, the locking is achieved by the mixer assembly 30a itself, so that the structure is simpler. Among them, the coupling part 33 is constructed as a locking part, and by the rotation of the locking part relative to the mixing barrel 31, the locking part abuts against or contacts with the installation part 11 in the first direction. The locking part may be one of the upper cover 332a or the lower cover 333a, or other parts that are connected to the coupling part 33a, which may be locked and unlocked by abutting against or being separated from the installation part 11 in the first direction. Therefore, the structure is simple, and it is easy to manufacture.

Certainly, the locking part may also be a part independent of the coupling part 33a. The locking part is movably connected to the mixing barrel 31, and is fixed relative to the mixing barrel 31 in the first direction. The locking part is capable of switching between a locking state and an unlocking state relative to the installation part 11. In the locking state, the installation part 11 limits the locking part from moving in the first direction; and in the unlocking state, the installation part 11 releases the locking part, and the locking part is allowed to move in the first direction. Among them, the locking part includes a gripping part 371a, and the installation part 11 includes an accommodating cavity 110 for receiving the mixer assembly 30a. In the first direction, the installation part 11 includes an inner side where the accommodating cavity 110 is disposed and an opposite outer side, the gripping part 371a is located at the outer side, and the gripping part 371a is capable of operably driving the locking part to rotate between the locking state and the unlocking state. In the present embodiment, the inner side is a rear side, and the outer side is the front side.

In an example, the first rotation axis Z1 is disposed in a vertical direction and is perpendicular to the first direction. The rotation axis of the locking part is coaxial with the first rotation axis Z1, facilitating the assembly and the positioning of the locking part and the mixing barrel 31. The mixing barrel 31 includes a feeding chamber 311 and a mixing chamber 312 communicating with each other in the vertical direction, the stirring blade 35 is located inside the mixing chamber 312, and the locking part includes a connecting body being concentrically arranged with the stirring blade 35. The connecting body is a main body portion of the lower cover 333a. The gripping part 371a extends outwards from an outer periphery of the connecting body, and the connecting body is disposed below the mixing chamber 312. A rotation axis of the connecting body is concentric with the first rotation axis Z1 of the stirring blade 35, which facilitates the positioning and connection of the connecting body.

The installation part 11 includes a top plate 113, a bottom plate 112, and a side plate 114. The top plate 113 and the bottom plate 112 are disposed opposite to each other in the vertical direction, and the side plates 114 connect the top plate 113 and the bottom plate 112. The top plate 113, and the bottom plate 112, and the side plates 114 define an accommodating cavity 110 together.

The side plate 114 includes a left side plate and a right side plate. The accommodating cavity 110 has an installation opening 111, and the top plate 113 is provided with a placing groove 115 communicating with the installation opening 111. The mixer assembly 30a enters the placing groove 115 from the installation opening 111 in the first direction, and a portion of the mixer assembly 30a is located in the accommodating cavity 110 and is limited by the top plate 113 in the direction of the first rotation axis Z1. The mixing barrel 31 includes a contraction portion 313, and the contraction portion 313 is disposed at a joint between the feeding chamber 311 and the mixing chamber 312. The contraction portion 313 enters the placing groove 115, and the top wall of the mixing chamber 312 is limited by the top plate 113. By using structure of the mixing barrel 31 to limit the mixing barrel 31 in the vertical direction, the installation of the mixer assembly 30a itself is more reliable.

Furthermore, the connecting body includes two arc-shaped walls 373a that are arranged concentrically with the first rotation axis Z1 of the stirring blade 35. The two arc-shaped walls 373a are arranged at intervals in a circumferential direction, and a first notch 376 and a second notch 377 are formed between the two arc-shaped walls 373a at intervals in the circumferential direction. The installation part 11 is provided with a stopper block 118. In the locking state, one of the arc-shaped walls 373a abuts against the stopper block 118. In the unlocking state, the first notch 376 corresponds to a position of the stopper block 118, and the second notch 377 corresponds toa position of the first transmission member 41. The first notch 376 is used for cooperating with the stopper block 118 to unlock the connecting body, and the second notch 377 is used for avoiding an interference between the two arc-shaped walls 373a and the first transmission member 41 when installing or disassembling the mixer assembly 30. An opening size of the second notch 377 is greater than that of the first notch 376, which facilitates engagement between the first transmission member 41 and the second transmission member 42, and the arc-shaped wall 373a will not interfere the first transmission member 41 when the connecting body is rotated. The connecting body is unlocked with the installation part 11 by utilizing shapes of the two notches and the two arc-shaped walls through rotating the connecting body, so that the structure is simple, and it is convenient for operating. Among them, the gripping part 371a extends forwards radially from a position corresponding to the first notch 376, so that it is convenient for gripping when unlocking, and thus the operation is effortless.

In addition, the two arc-shaped walls 373a are respectively provided with clamping jaws 378, and the two side plates 14a are respectively provided with clamping blocks 148 fitted with the clamping jaws 378. The clamping claws 378 on the two arc-shaped walls 373a are respectively clamped or separated from the corresponding clamping blocks 148 in opposite directions. By provided the clamping claws 378 and clamping blocks 148 fitted with each other, the installation of the mixer assembly 30a is more reliable, and meanwhile tactile feedback is provided during locking and unlocking operations, making it is convenient for a user to perceive.

In the following, the disassembly and installation processes of the mixer assembly 30a will be described in details. In the FIG. 11, the mixer assembly 30a at a left side is in the locking state. When it is necessary to clean the mixer assembly 30a, a force is applied to the gripping part 371a in an unlocking direction, to make the gripping part 371a drive the locking part (the coupling part 33a) to rotate relative to the installation part 11, the clamping jaws 378 are separated from the clamping block 148, until the first notch 376 corresponds to the position of the stopper block 118, and then the locking between the locking part and the installation part 11 in the first direction is released. In the FIG. 11, the mixer assembly 30a at a right side is in an unlocking state. Since the locking part is rotated relative to the mixing barrel 31, during an unlocking process, a position of the mixing barrel 31 is not changed relative to the supporting base 10. After unlocking, the gripping part 371a is operated to move outwards in the first direction. The gripping part 371a will drive the locking part (the coupling part 33a), the mixing barrel 31, and the second transmission member 42 to be separated from the supporting base 10 together. If it is required to continue to separate the locking part and the mixing barrel 31, it may be implemented by simply moving the locking part relative to the mixing barrel 31 in the first rotation axis Z1 direction of the stirring blade 35. If it is required to clean the stirring blade 35 separately, it can be implemented by removing the stirring blade 35 from the transmission shaft 331, and then they are installed to their original positions one by one after cleaning.

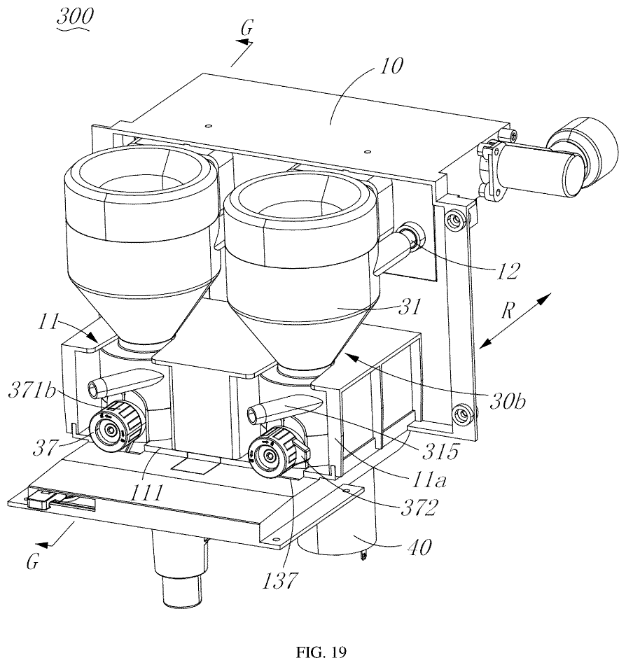

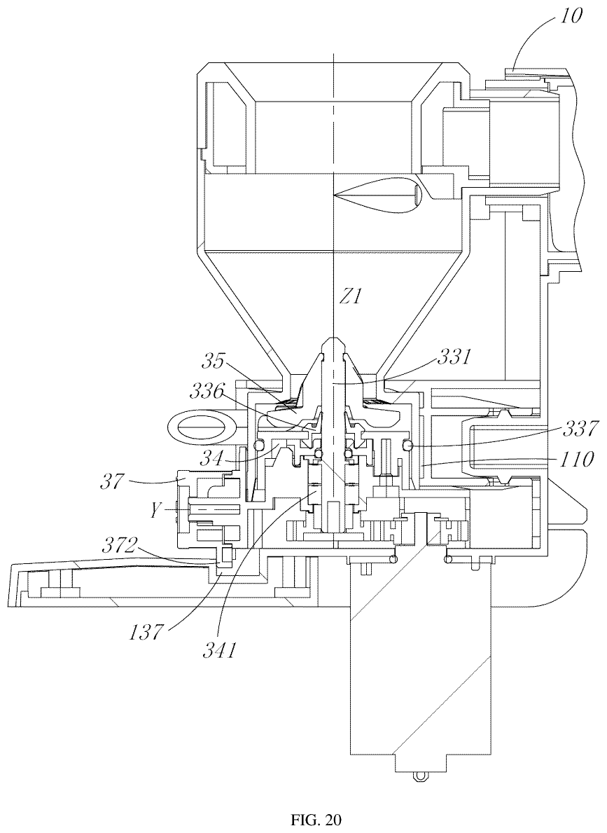

Referring to FIG. 19 to FIG. 22, in an implementation, the mixing device 300 includes a supporting base 10, a mixer assembly 30b installed on the supporting base 10, and a motor 40 disposed on the supporting base 10. The supporting base 10 has an installation part 11, and the mixer assembly 30b is connected to the installation part 11. The mixer assembly 30b includes a mixing barrel 31 and a stirring blade 35 located inside the mixing barrel 31. The motor 40 is used for driving the stirring blade 35 to rotate around a first rotation axis Z1, and thereby stirring a mixture inside the mixing barrel 31.

Among them, the mixing device 300 also includes a transmission mechanism disposed between the motor 40 and the stirring blade 35. The transmission mechanism includes a first transmission member 41 and a second transmission member 42. The first transmission member 41 is disposed on the installation part 11, and is connected to the motor 40 in a transmission manner. The second transmission member 42 is connected to the stirring blade 35 in a transmission manner. A liquid inlet pipeline 12 is connected to the supporting base 10, and the liquid inlet pipeline 12 communicates with the mixing barrel 31 in a first direction. The mixer assembly 30b is detachably connected to the installation part 11. In the first direction, the second transmission member 42 and the mixer assembly 30b are connected to or separated from the installation part 11 as an integral unit, so that it is very convenient for a user to disassemble and assemble.

In an example, an axis of motor 40 is parallel to the first rotation axis Z1 of the stirring blade 35. The axis of the motor 40 and the first rotation axis Z1 of the stirring blade 35 are arranged side by side in the first direction. That is, the first rotation axis Z1 of the stirring blade 35 is arranged side by side with the axis of the motor 40 in a front to rear direction, or it may be considered that the first transmission member 41 and the second transmission member 42 are arranged side by side. The first transmission member 41 and the second transmission member 42 are both constructed as gears arranged side by side in the front to rear direction, so that engagement and disengagement operations are more effortless, and thus it is convenient for the disassembly and the installation of the mixer assembly 30b.

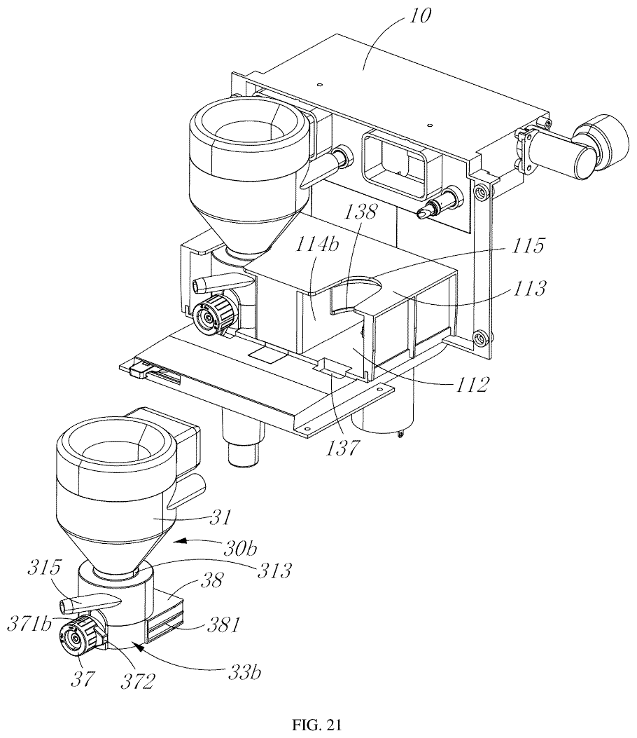

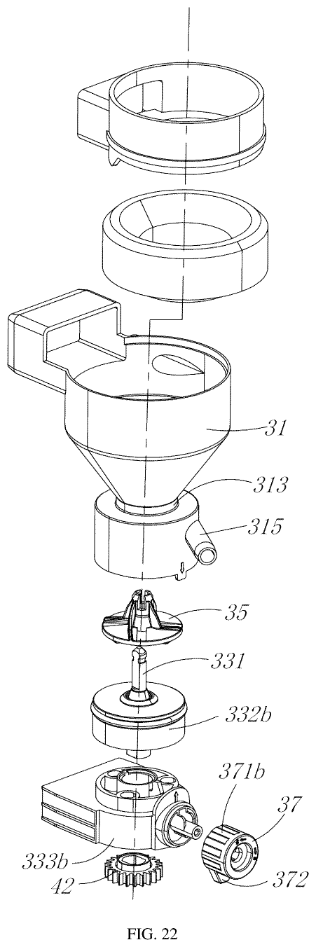

Referring to FIG. 21 and FIG. 22, the mixer assembly 30b also includes a coupling part 33b detachably connected to a bottom of the mixing barrel 31. The coupling part 33b includes a transmission shaft 331 which connects the second transmission member 42 and the stirring blade 35. The stirring blade 35 is disposed on a side of the coupling part 33b in an axial direction, and the second transmission member 42 is disposed on another side of the coupling part 33b in the axial direction. The coupling part 33b may include an upper cover 332b and a lower cover 333b which are assembled together by screws. A supporting space 34 is defined between the upper cover 332b and the lower cover 333b, and a supporting part 341 such as a bearing, a shaft sleeve, and the like may be disposed in the supporting space 34. A sealing ring 336 is disposed between the transmission shaft 331 and the upper cover 332b, to prevent a liquid inside the mixing barrel 31 from leaking through a gap between the transmission shaft 331 and the upper cover 332b. A portion of the lower cover 333a protrudes upwards, and extends into the upper cover 332b. The upper cover 332b extends into interior of the mixing barrel 31, and a bottom edge of the mixing barrel 31 is capable of abutting against the lower cover 333b. A sealing loop 337 is disposed between the upper cover 332b and the interior of the mixing barrel 31, to prevent the liquid inside the mixing barrel 31 from leaking through a gap between the mixing barrel 31 and the upper cover 332b.

In an example, the coupling part 33b is fixed relative to the mixing barrel 31. The coupling part 33b is connected to the locking part, and it may be considered that the locking part is a part independent of the coupling part 33b. The locking part is movably connected to the mixing barrel 31 through the coupling part 33b, and the locking part is indirectly connected to the barrel 31. The locking part is fixed relative to the mixing barrel 31 in the first direction. The locking part is capable of switching between a locking state and an unlocking state relative to the installation part 11. In the locking state, the installation part 11 limits movement of the locking part in the first direction; and in the unlocking state, the installation part 11 releases the locking part, and the locking part is allowed to move in the first direction.

The locking part includes a gripping part 371b, the installation part 11 includes an accommodating cavity 110 for receiving the mixer assembly 30b. In the first direction, the installation part 11 includes an inner side where the accommodating cavity 110 is disposed and an opposite outer side, and the gripping part 371b is located at the outer side. The gripping part 371b is capable of operably driving the locking part to rotate between the locking state and the unlocking state. In the present embodiment, the inner side is a rear side, and the outer side is a front side.

In an example, the first rotation axis Z1 is disposed in a vertical direction and is perpendicular to the first direction. A second rotation axis Y of the locking part is parallel to the first direction, so that it facilitates the fitting between the locking part and the installation part 11. The mixing barrel 31 includes a feeding chamber 311 and a mixing chamber 312 communicating with each other in the vertical direction, and the stirring blade 35 is located inside the mixing chamber 312. The installation part 11 includes a top plate 113, a bottom plate 112, and a side plate 114. The top plate 113 and the bottom plate 112 are disposed opposite to each other in the vertical direction, and the side plate 114 connects the top plate 113 and the bottom plate 112. The top plate 113, the bottom plate 112, and the side plate 114 define an accommodating cavity 110 together. The side plates 114 include a left side plate and a right side plate. The accommodating cavity 110 has an installation opening 111, and a placing groove 115 is disposed on the top plate 113 and communicates with the installation opening 111. The mixer assembly 30b enters the placing groove 115 from the installation opening 111 in the first direction. A portion of the mixer assembly 30b is located in the accommodating cavity 110, and is limited by the top plate 113 in the direction of the first rotation axis Z1. The mixing barrel 31 includes a contraction portion 313, and the contraction portion 313 is disposed at a joint between the feeding chamber 311 and the mixing chamber 312. The contraction portion 313 enters the placing groove 115, and a top wall of the mixing chamber 312 is limited by the top plate 113. By using a structure of the mixing barrel 31 itself to limit the mixing barrel 31 in the vertical direction, the installation of the mixer assembly 30b is more reliable.

Furthermore, a guide block 38 is disposed on a rear side of the coupling part 33b, and rib plates 381 extending in the first direction are disposed on left and right sides of the guide block 38, respectively. The accommodating cavity 110 is provided with a limiting rib 138, and the guide block 38 guides the mixer assembly 30b to be assembled into from the installation opening 111 through the rib plates 381 on the two sides. The guide block 38 is located below the limiting rib 138, to further achieve a limitation of the position of the mixer assembly 30b in the vertical direction through the limiting rib 138.

The locking part is connected to a front side of the coupling part 33b. The locking part is constructed as a knob 37, and a circumferential surface of the knob 37 is constructed as the gripping part 371b. The locking part also includes a locking block 372 protruding from the gripping part 371b. The installation part 11 is provided with a locking groove 137, and the gripping part 371b moves relative to the mixing barrel 31 to allow the locking block 372 to extend into or be separated from the locking groove 137. In the present embodiment, the locking part rotates around an axis parallel to the first direction, and the locking block 372 may protrude radially from the locking block 37.

In the following, disassembly and installation processes of the mixer assembly 30b will be described in details. In FIG. 19, the mixer assembly 30b at a left side is in a locking state. When the mixer assembly 30b is necessary to clean, the knob 37 is rotated in an unlocking direction indicated on the knob 37, to make the knob 37 drive the locking block 372 to be separated from the locking groove 137 on the installation part 11, so that the locking in the first direction between the mixer assembly 30b and the installation part 11 is released. During the unlocking process, it is only necessary to rotate the knob 37. In FIG. 19, the mixer assembly 30b at a right side is in an unlocking state. After unlocking, by gripping the knob 37 and making it move outwards, the knob 37 will drive the coupling part 33b, the mixing barrel 31, and the second transmission member 42 to be separated from the supporting base 10 together. If it is necessary to continue to separate the coupling part 33b and mixing barrel 31, it is only necessary to enable the coupling part 33b to move relative to the mixing barrel 31 in the first rotation axis Z1 direction of the stirring blade 35. If it is necessary to clean the stirring blade 35, the stirring blade 35 is removed from the transmission shaft 331, and after cleaning, they are installed to their original position one by one.

In the above embodiment, at least a portion of a cavity surface of the feeding chamber 311 is a circular arc surface. In an example, a delivering direction of the liquid inlet pipeline 12 is tangential to the circular arc surface, so that the delivered liquid (for example water) is capable of flowing in a circumference direction of the feeding chamber 311 to pass through more of the cavity surface. That is, the outflowed water rotates along the wall of the mixing barrel 31 may wash away the powders adhering to the inner wall, so that the powders fellow into the feeding chamber 311 are prevented from adhering to the cavity surface of the feeding chamber 311. Moreover, it may cause an eddy current to effectively dissolve the powders in the liquid (for example water). In addition, the mixing barrel 31 is provided with an output pipeline 315 that communicates with the mixing chamber 312. In an example, a delivering direction of the output pipeline 315 is tangential to an outer peripheral surface of the stirring blade 35, so that the mixed liquid to be flung out under an action of the stirring blade 35, which facilitates discharging a liquid.

In the present disclosure, by the second transmission member and the mixer assembly are connected or separated from the installation part as an integral unit, a user may disassemble the mixer assembly for subsequent cleaning by themselves. Disassembly and assembly are merely required to be separated or connected in corresponding directions, so that it is simple and convenient for a user to operate, and it is labor-saving, thereby it is not necessary to disassemble and maintain by a professional, and thus a maintenance cost of the mixing device for the user is reduced. By disassembling the entire mixer assembly from the supporting base, a more thorough cleaning may be performed without the requirement for removing the motor 40 together, so that it is not necessary to provide a corresponding relief structure for the motor 40, and thus a space utilization of the machine is increased, and the disassembly operation by the user are facilitated.

It should be understood that, although this specification is described according to the embodiments, but not each embodiment merely contains an independent technical solution. This description of the specification is merely for the sake of clarity. Those skilled in the art should consider the specification as a whole, and the technical solutions in each embodiment may also be appropriately combined to form other embodiments that are understandable to those skilled in the art. The series of detailed descriptions listed above are only specific descriptions of the feasible embodiments of the present invention and disclosure, and they are not used to limit the protection scope of the present invention and disclosure. Any equivalent embodiments or changes that do not depart from the technical spirit of the present invention and disclosure should be included in the protection scope of the present invention and disclosure.

A series of detailed explanations listed above are merely specific descriptions of feasible implementations of the present disclosure, and they are not intended to limit the protection scope of the present disclosure. Any equivalent implementation or modification that does not depart from the spirit of the present disclosure should be included inside the protection scope of the present disclosure.

What is claimed is:

1. A mixing device, comprising:
a supporting base having an installation part;
a mixer assembly detachably connected to the installation part, and comprising a mixing barrel and a stirring blade located inside the mixing barrel; and
a motor disposed on the supporting base, and configured to drive the stirring blade to rotate around a first rotation axis, wherein,
in a direction perpendicular to the first rotation axis, an axis of the motor is misaligned with the first rotation axis;
the mixing device further comprises a transmission mechanism disposed between the motor and the stirring blade, the transmission mechanism is configured to connect the motor and the stirring blade, the transmission mechanism comprises a first transmission member and a second transmission member;
the first transmission member is disposed on the installation part, and is connected to the motor in a transmission manner, and the second transmission member is connected to the stirring blade in a transmission manner; and
the second transmission member and the mixer assembly are connected to or separated from the installation part as an integral unit.

2. The mixing device according to claim 1, wherein the mixer assembly further comprises a coupling part connected to a bottom of the mixing barrel, the coupling part comprises a transmission shaft, the transmission shaft connects the second transmission member and the stirring blade, and in an axial direction, the stirring blade is disposed on a side of the coupling part, and the second transmission member is disposed on another side of the coupling part.

3. The mixing device according to claim 2, wherein a discharging outlet is disposed on a side of the coupling part corresponding to the second transmission member, the coupling part defines a supporting space, and a discharging valve is disposed in the supporting space; when the mixer assembly is connected to the installation part, the discharging valve opens the discharging outlet; and when the mixer assembly is separated from the installation part, the discharging valve closes the discharging outlet.

4. The mixing device according to claim 3, wherein the discharging valve comprises a valve body and an elastic element acting on the valve body, and the installation part is provided with a butt joint block; and the butt joint block is configured to abut against the valve body to make the valve body overcome an action of the elastic element to open the discharging outlet.

5. The mixing device according to claim 2, wherein the coupling part is capable of rotating relative to the mixing barrel, to limit or allow the mixer assembly to be separated from the installation part.

6. The mixing device according to claim 2, wherein the mixer assembly is connected to or separated from the installation part in a first direction; a locking part is moveably connected to the coupling part, and the locking part is fixed relative to the coupling part in the first direction; and the locking part moves relative to the coupling part to be locked or unlocked with the installation part in the first direction.

7. The mixing device according to claim 1, wherein the axis of the motor is parallel to the first rotation axis, the mixer assembly is connected to or separated from the installation part in a first direction, and the first direction is perpendicular to the first rotation axis; and in the first direction, the axis of the motor is disposed side by side with the first rotation axis, or in a direction perpendicular to the first direction, the axis of the motor is disposed side by side with the first rotation axis.

8. The mixing device according to claim 1, wherein the mixer assembly further comprises a locking part connected to the mixing barrel, and the mixer assembly is connected to or separated from the installation part in a first direction; the locking part is capable of moving relative to the mixing barrel, and is fixed relative to the mixing barrel in the first direction; the locking part is capable of switching between a locking state and an unlocking state relative to the installation part, and in the locking state, the installation part limits the locking part from moving in the first direction; and in the unlocking state, the installation part releases the locking part, and the locking part is allowed to move in the first direction.

9. The mixing device according to claim 8, wherein the locking part comprises a gripping part, and the installation part comprises an accommodating cavity for receiving the mixer assembly; in the first direction, the installation part comprises an inner side where the accommodating cavity is disposed and an opposite outer side, and the gripping part is located on the outer side; and the gripping part is capable of operably driving the locking part to rotate between the locking state and the unlocking state.

10. The mixing device according to claim 9, wherein the first rotation axis is disposed in a vertical direction, and the first direction is perpendicular to the first rotation axis; and a rotation axis of the locking part is coaxial with the first rotation axis, or the rotation axis of the locking part is parallel to the first direction.

11. The mixing device according to claim 10, wherein a liquid inlet pipeline is connected to the supporting base, and the liquid inlet pipeline communicates with the mixing barrel in the first direction.

12. The mixing device according to claim 9, wherein the mixing barrel comprises a feeding chamber and a mixing chamber communicating with each other in a vertical direction, the stirring blade is located in the mixing chamber, the locking part comprises a connecting body that is concentrically arranged with the stirring blade, the gripping part extends outwards from an outer periphery of the connecting body, and the connecting body is disposed below the mixing chamber.

13. The mixing device according to claim 8, wherein the installation part comprises a top plate, a bottom plate, and a side plate, the top plate and the bottom plate are disposed opposite each other in a vertical direction, and the side plate connects the top plate and the bottom plate; the top plate, the bottom plate, and the side plate define an accommodating cavity together, the accommodating cavity has an installation opening, the top plate is provided a placing groove communicating with the installation opening, and the mixer assembly enters the placing groove in the first direction from the installation opening; and a portion of the mixer assembly is located in the accommodating cavity, and is limited by the top plate in the first rotational axis direction.

14. The mixing device according to claim 13, wherein the mixing barrel comprises a feeding chamber and a mixing chamber communicating with each other in a vertical direction, the stirring blade is located inside the mixing chamber, the bottom of the mixing chamber radially extends outwards to form a skirt edge, and the skirt edge is limited by the top plate.

15. The mixing device according to claim 13, wherein the mixing barrel comprises a feeding chamber and a mixing chamber communicating with each other in a vertical direction, the stirring blade is located inside the mixing chamber, the mixing barrel comprises a contraction portion, the contraction portion is disposed at a joint between the feeding chamber and the mixing chamber, the contraction portion enters the placing groove, and a top wall of the mixing chamber is limited by the top plate.

16. The mixing device according to claim 12, wherein the connecting body comprises two arc-shaped walls disposed opposite to each other and two straight walls, and the two straight walls are disposed opposite to each other and are separately connected to the two arc-shaped walls; the two arc-shaped walls are concentrically arranged with the stirring blade, and a distance between the two straight walls is substantially the same as a width of the installation opening; the installation part is provided with a blocking wall, and in the locking state, one of the two straight walls abuts against the blocking wall; and in the unlocked state, the two straight walls are respectively flush with the installation opening.

17. The mixing device according to claim 12, wherein the connecting body comprises two arc-shaped walls concentrically arranged with the first rotation axis, a first notch and a second notch spaced along a circumferential direction are formed between the two arc-shaped walls, the installation part is provided with a stopper block, and in the locking state, one of the two arc-shaped walls abuts against the stopper block; and in the unlocking state, the first notch corresponds to a position of the stopper block, and the second notch corresponds to a position of the first transmission part; an opening size of the second notch is different from an opening size of the first notch.

18. The mixing device according to claim 17, wherein the two arc-shaped walls are respectively provided with clamping jaws, the installation part is provided with two side plates, and the two side plates are respectively provided with clamping blocks fitted with the clamping jaws, and the clamping jaws on the two arc-shaped walls are respectively clamped or separated from the corresponding clamping blocks in opposite directions.

19. The mixing device according to claim 1, wherein the first transmission member is in transmission connection with the second transmission member.

20. The mixing device according to claim 9, wherein the locking part further comprises a locking block protruding from the gripping part, the installation part is provided with a locking groove, the gripping part is capable of moving relative to the mixing barrel, to make the locking block engage into or disengage from the locking groove.
